(19) United States
(12) Patent Application Publication
(10) Pub. No.: US 2005/0083291 A1
(43) Pub. Date: Apr. 21, 2005

(54) Semiconductor memory device and flat panel display using the same

(76) Inventors: Bo-Yong Chung, Suwon-si (KR); Yong-Sung Park, Suwon-si (KR); Han-Hee Yoon, Suwon-si (KR)

Correspondence Address: CHRISTIE, PARKER & HALE, LLP, PO BOX 7068, PASADENA, CA, 91109-7068, US

(21) Appl. No.: 10/917,868

(22) Filed: Aug. 13, 2004

(30) Foreign Application Priority Data
Oct. 17, 2003 (KR) 2003-0072578

(51) Int. Cl. G09G 3/36

(52) U.S. Cl. 345/100

(57) ABSTRACT

An SRAM cell having a latch circuit including two inverters coupled in a chain format. Each inverter is coupled to power through a transistor, and the transistor is turned off when data is written to the SRAM. As a result, the data is easily written to the SRAM cell without data collision since performance of the latch circuit is degraded. Such SRAM cell may be used in a flat panel display to temporarily store digital signals corresponding to data signals for displaying video.

### CROSS REFERENCE TO RELATED APPLICATION

This application claims priority to and the benefit of Korean Patent Application No. 2003-72578 filed on Oct. 17, 2003 in the Korean Intellectual Property Office, the entire content of which is incorporated herein by reference.

### BACKGROUND OF THE INVENTION

(a) Field of the Invention

The present invention relates to a semiconductor memory device and a flat panel display using the same. More specifically, the present invention relates to an SRAM and a flat panel display using the same.

(b) Description of the Related Art

In general, as shown in FIG. 1, an SRAM (static random access memory) has a latch circuit with two inverters in an inverter chain format. The inverters respectively include two opposite transistor pairs M1 and M2, and M3 and M4. Gates of the transistors M1 and M2 and gates of the transistors M3 and M4 are input ends of the respective inverters. The input end of each inverter is connected to an output end N1 or N2 of the other inventor. The output ends N1 and N2 of the inverters are also connected, respectively, to transistors M5 and M6 having gates connected to a word line WORD. The transistors M5 and M6 are respectively connected to a bit line BIT and an inverse bit line BITb, wherein the inverse bit line BITb supplies inverse data of the data provided by the bit line BIT. A power supply voltage VDD for supplying a high level voltage and a power supply voltage VSS for supplying a low level voltage are respectively connected to the ends of the inverters.

When the node N1 has a high level voltage in the above-noted SRAM, the node N2 has a low level voltage, the transistors M1 and M4 are turned on by the voltages at the nodes N1 and N2, and the nodes N1 and N2 are respectively maintained at a high level voltage and a low level voltage by the power supply voltages VDD and VSS. When the transistors M5 and M6 are turned on and a low level voltage is applied through the bit line BIT, the node N1 tends to be maintained at the high level voltage by the power supply voltage VDD, and hence, it may take more time for the node N1 to reach the low level voltage, or the node N1 may not reach the low level voltage.

### SUMMARY OF THE INVENTION

In the present invention, a semiconductor memory device for easy data writing is provided.

In the present invention, inverters of an SRAM cell are decoupled from power when data is written to the SRAM cell.

In an exemplary embodiment of the present invention, a semiconductor memory device includes a first inverter having an output end coupled to a first node, and a second inverter having an output end coupled to a second node. A first switch is coupled between a bit line for transmitting first data and the first node, and a second switch is coupled between an inverse bit line for transmitting second data having a level opposite the level of the first data and the second node. At least one third switch is coupled between the first inverter and a first power for supplying a first level voltage and between the second inverter and the first power. An input end of the first inverter is coupled to the second node, and an input end of the second inverter is coupled to the first node.

A period for turning on the first and second switches may at least partially overlap with a period for turning off said at least one third switch. Further, the period for turning on the first and second switches may include the period for turning off said at least one third switch.

The first inverter may include a first transistor having a first type coupled between said at least one third switch and the first node, and a second transistor having a second type coupled between the first node and a second power for supplying a second level voltage. The second inverter may include a third transistor having the first type coupled between said at least one third switch and the second node, and a fourth transistor having the second type coupled between the second node and the second power. The first node may be coupled to gates of the third and fourth transistors, and the second node may be coupled to gates of the first and second transistors.

The first, second, third and fourth transistors may be thin film transistors formed on a substrate. In addition, the first, second and third switches may be thin film transistors formed on a substrate.

In another exemplary embodiment of the present invention, a semiconductor memory device includes a first inverter having an output end coupled to a first node and an input node coupled to a second node, and a second inverter having an output end coupled to the second node and an input node coupled to the first node. The semiconductor memory device also includes a first power supply line for supplying a first voltage to the first and second inverters, and a second power supply line for supplying a second voltage to the first and second inverters. The first power supply line is decoupled from the first and second inverters when data are applied to the first and second nodes.

The semiconductor memory device may further include a first switch coupled between the first power supply line and the first inverter, and a second switch coupled between the first power supply line and the second inverter. The first and second switches may be turned off when the data are applied to the first and second nodes.

The semiconductor memory device may further include a first switch coupled between the first power supply line and the first inverter and between the first power supply line and the second inverter. The first switch may be turned off when the data are applied to the first and second nodes.

In yet another exemplary embodiment of the present invention, a flat panel display having a semiconductor memory device discussed above is provided.

In still another exemplary embodiment of the present invention, a flat panel display includes a display region for displaying video. The display region includes a plurality of data lines arranged in a column direction on an insulation substrate and a plurality of scan lines arranged in a row direction. A data driver, formed on the insulation substrate, transmits data signals for displaying the video to the data lines. A frame memory, formed on the insulation substrate, temporarily stores digital signals which correspond to the data signals, and outputs the digital signals to the data driver. The frame memory includes: a plurality of first signal lines, arranged in the column direction, for transmitting the digital signals; a plurality of second signal lines, arranged in the column direction, for transmitting inverse signals of the digital signals applied to the first signal line; a plurality of third signal lines, arranged in the row direction, for transmitting select signals; and a plurality of SRAM cells coupled to the first, second and third signal lines, and arranged in a matrix format. One said SRAM cell is selected by a corresponding said selecting signal applied to a corresponding said third signal line, and is decoupled from a first power for supplying a first voltage when receiving a corresponding said digital signal from a corresponding said first signal line.

Each said SRAM cell may include: a first inverter having an output end coupled to a corresponding said first signal line through a first transistor, and an input end coupled to a corresponding said second signal line through a second transistor; and a second inverter having an output end coupled to the input end of the first inverter, and an input end coupled to the output end of the first inverter. At least one third transistor may be coupled between a first end of the first inverter and the first power and between a first end of the second inverter and the first power. Gates of the first and second transistors may be coupled to a corresponding said third signal line. A second end of the first inverter and a second end of the second inverter may be coupled to a second power for supplying a second voltage, and said at least one third transistor may be turned off when the first and second transistors are turned on and the digital signals and the inverse digital signals are applied through the first and second signal lines.

The first inverter may include a fourth transistor having a first type coupled between the first end and the output end of the first inverter and a fifth transistor having a second type coupled between the output end and the second end of the first inverter. The second inverter may include a sixth transistor having the first type coupled between the first end and the output end of the second inverter and a seventh transistor having the second type coupled between the output end and the second end of the second inverter. Gates of the fourth and fifth transistors may be coupled to the input end of the first inverter, and gates of the sixth and seventh transistors may be coupled to the input end of the second inverter.

The fourth, fifth, sixth and seventh transistors may be thin film transistors formed on the insulation substrate. In addition, the thin film transistors may have a semiconductor layer of polycrystalline silicon as a channel region.

### BRIEF DESCRIPTION OF THE DRAWINGS

The accompanying drawings, together with the specification, illustrate exemplary embodiments of the present invention, and, together with the description, serve to explain the principles of the present invention:

FIG. 1 shows an equivalent circuit diagram of a conventional SRAM cell;

FIG. 2 shows an equivalent circuit diagram of an SRAM cell according to an exemplary embodiment of the present invention;

FIG. 3 shows an equivalent circuit diagram having data writing transistors and data reading transistors connected to the SRAM cell of FIG. 2;

FIG. 4 shows a driving timing diagram of the equivalent circuit of FIG. 3;

FIG. 5 shows a block diagram of a display panel of a flat panel display according to an exemplary embodiment of the present invention;

FIG. 6 shows a frame memory of FIG. 5; and

FIG. 7 shows an equivalent circuit diagram of an SRAM cell according to another exemplary embodiment of the present invention.

### DETAILED DESCRIPTION

In the following detailed description, only certain exemplary embodiments of the present invention are shown and described, simply by way of illustration. As those skilled in the art would realize, the described exemplary embodiments may be modified in various different ways, all without departing from the spirit or scope of the present invention. Accordingly, the drawings and description are to be regarded as illustrative in nature, and not restrictive.

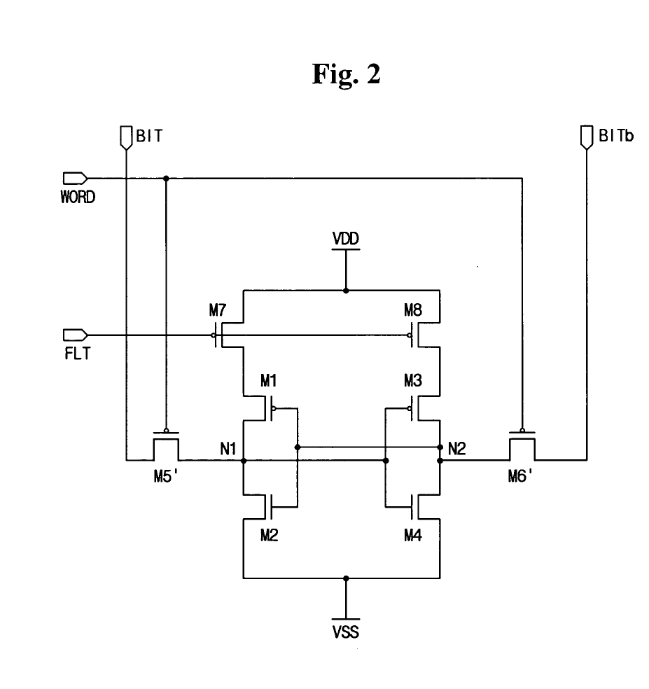

Referring to FIG. 2, a semiconductor memory device including an SRAM cell according to an exemplary embodiment of the present invention will be described in detail.

As shown, the SRAM cell includes eight transistors M1 to M8. The transistors M1 and M2 are connected in series, and gates of the transistors M1 and M2 are connected to each other to thus configure an inverter. Further, the transistors M3 and M4 are connected in series, and gates of the transistors M3 and M4 are connected to each other to thus configure another inverter. The two inverters configure an inverter chain type latch circuit. The transistors M1 and M2 are opposite types from each other, and the transistors M3 and M4 are opposite types from each other. In the described embodiment, the transistors M1 and M3 are p-channel FETs (field-effect transistors), and the transistors M2 and M4 are n-channel FETs. In other embodiments, any other suitable transistors may be used as the transistors M1 to M4.

A drain of the transistor M1 and a drain of the transistor M2 are connected to configure a cell node N1 which is connected in common to the gates of the transistors M3 and M4. In the same manner, a drain of the transistor M3 and a drain of the transistor M4 are connected to configure a cell node N2 which is connected in common to the gates of the transistors M1 and M2. The cell node N1 is an output end of the inverter formed by the transistors M1 and M2 and an input end of the inverter formed by the transistors M3 and M4. In the same manner, the cell node N2 is an output end of the inverter formed by the transistors M3 and M4 and an input end of the inverter formed by the transistors M1 and M2. Sources of the transistors M2 and M4 are connected to the power supply voltage VSS (or a power supply line) for supplying a low level voltage.

A transistor M7 is connected between the power supply voltage VDD for supplying the high level voltage and a source of the transistor M1, and a transistor M8 is connected between the power supply voltage VDD and a source of the transistor M3. Gates of the transistors M7 and M8 are connected to a floating line FLT, and the transistors M7 and M8 are turned on and off according to a float signal provided from the floating line FLT.

An access transistor M5′ is connected between the cell node N1 and the bit line BIT, and a gate of the transistor M5′ is connected to the word line WORD. An access transistor M6′ is connected between the cell node N2 and the inverse bit line BITb, and a gate of the transistor M6′ is also connected to the word line WORD. The p-type FETs are used for the transistors M5′, M6′, M7 and M8 in the described embodiment. In other embodiments, n-type FETs or transmission gate (CMOS) transistors may be used as one or more of the transistors M5′, M6′, M7 and M8.

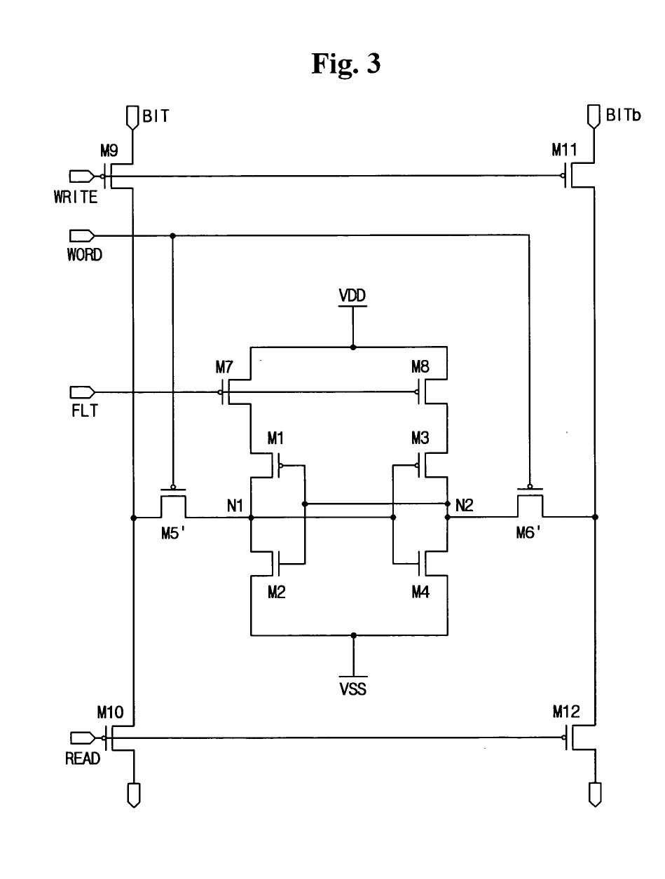

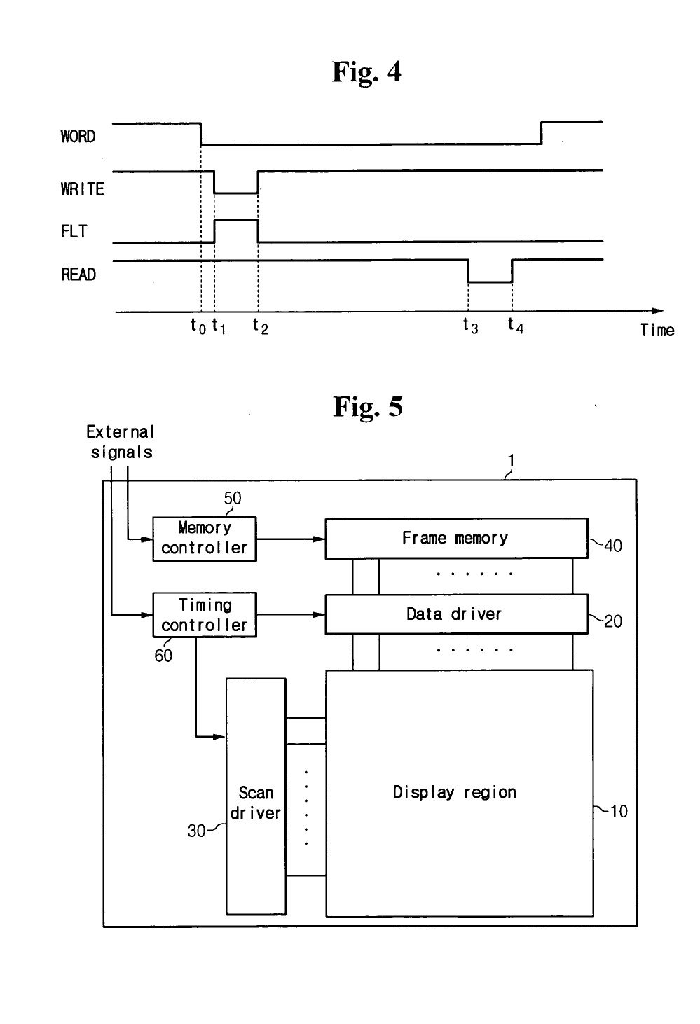

Referring to FIGS. 3 and 4, a method for writing and reading data to/from the SRAM cell of FIG. 2 will now be described in detail.

As shown in FIG. 3, the bit line BIT of the SRAM cell of FIG. 2 is connected to a data writing transistor M9 and a data reading transistor M10. In the same manner, the inverse bit line BITb of the SRAM cell of FIG. 2 is connected to a data writing transistor M11 and a data reading transistor M12. Gates of the data writing transistors M9 and M11 are connected to a data writing line WRITE for transmitting data writing signals, and gates of the data reading transistors M10 and M12 are connected to a data reading line READ for transmitting data reading signals. The transistors M9 to M12 in FIG. 3 are p-type FETs. In other embodiments, n-type FETs or transmission gate (CMOS) transistors may be used as one or more of the transistors M9-M12.

Referring to FIGS. 3 and 4, when a low-level selecting signal is applied to the word line WORD and the access transistors M5′ and M6′ are turned on at the time of t0, data may be written to the corresponding SRAM cell or date may be read therefrom.

Next, a high-level floating signal is applied to the floating line FLT and a low-level writing signal is applied to the data writing line WRITE at the time of t1. The transistors M7 and M8 are turned off to have the sources of the transistors M1 and M3 be floated, and the transistors M9 and M11 are turned on such that the data provided from the bit line BIT and the inverse data provided from the inverse bit line BITb are respectively passed through the access transistors M5′ and M6′ and then applied to the cell nodes N1 and N2.

When the data provided from the bit line BIT has a high level voltage ‘1,’ the voltage at the cell node N1 becomes high level, and the voltage at the cell node N2 becomes low level because of the low level voltage ‘0’ provided from the inverse bit line BITb. Similarly, when the data provided from the bit line BIT has a low level voltage ‘0,’ the voltage at the cell node N1 becomes low level, and the voltage at the cell node N2 becomes high level because of the high level voltage ‘1’ provided from the inverse bit line BITb.

Next, the floating signal provided from the floating line FLT becomes low level and the writing signal provided from the data writing line WRITE becomes high level at the time of t2. The access transistors M5′ and M6′ are turned off, and the cell nodes N1 and N2 are floated while the data provided from the bit line BIT and the inverse bit line BITb are applied. The transistors M7 and M8 are turned on, and the high level power supply voltage VDD is applied to the sources of the transistors M1 and M3.

In this instance, when a high level voltage is applied to the bit line BIT at the time of between t1 and t2, the transistors M1 and M4 are turned on because of the voltages at the cell nodes N1 and N2. That is, the transistor M1 is turned on such that the cell node N1 is maintained at the high level voltage by the high level power supply voltage VDD, and the transistor M4 is turned on such that the cell node N2 is maintained at the low level voltage by the low level power supply voltage VSS. Accordingly, the SRAM cell stores the data of the high level voltage ‘1.’

In addition, when a low level voltage is applied to the bit line BIT at the time of between t1 and t2, the transistors M2 and M3 are turned on because of the voltages at the cell nodes N1 and N2. That is, the transistor M2 is turned on such that the cell node N1 is maintained at the low level voltage by the low level power supply voltage VSS, and the transistor M3 is turned on such that the cell node N2 is maintained at the high level voltage by the high level power supply voltage VDD. Accordingly, the SRAM cell stores the data of the low level voltage ‘0.’

Next, when a low level reading signal is applied to the reading line READ at the time of between t3 and t4, the transistors M11 and M12 are turned on, and the voltages at the nodes N1 and N2 are output through the bit line BIT and the inverse bit line BITb, respectively. In other words, the data stored in the SRAM cell is output through the bit line BIT.

In this instance, when the data ‘0’ (a low level voltage) is applied through the bit line BIT while the data ‘1’ (a high level voltage) is stored in the SRAM cell prior to the time of t0, the voltage at the cell node N1 is to be switched to the low level voltage from the high level voltage. Since the transistor M7 is turned off, that is, the source of the transistor M1 is floated when a low level voltage is applied to the bit line BIT, performance of the latch circuit is degraded, and accordingly, the voltage at the cell node N1 can be switched to the low level voltage.

In the same manner, when the data ‘1’ is applied through the bit line BIT while the data ‘0’ (a high level voltage) is stored in the SRAM cell prior to the time of t0, the voltage at the cell node N1 can be switched to the high level voltage since the source of the transistor M1 is floated.

The high level period of the floating signal corresponds to the low level period of the writing signal in FIG. 4, and when the data can be sufficiently written, the two periods can partially overlap rather than having a full correspondence of the two periods.

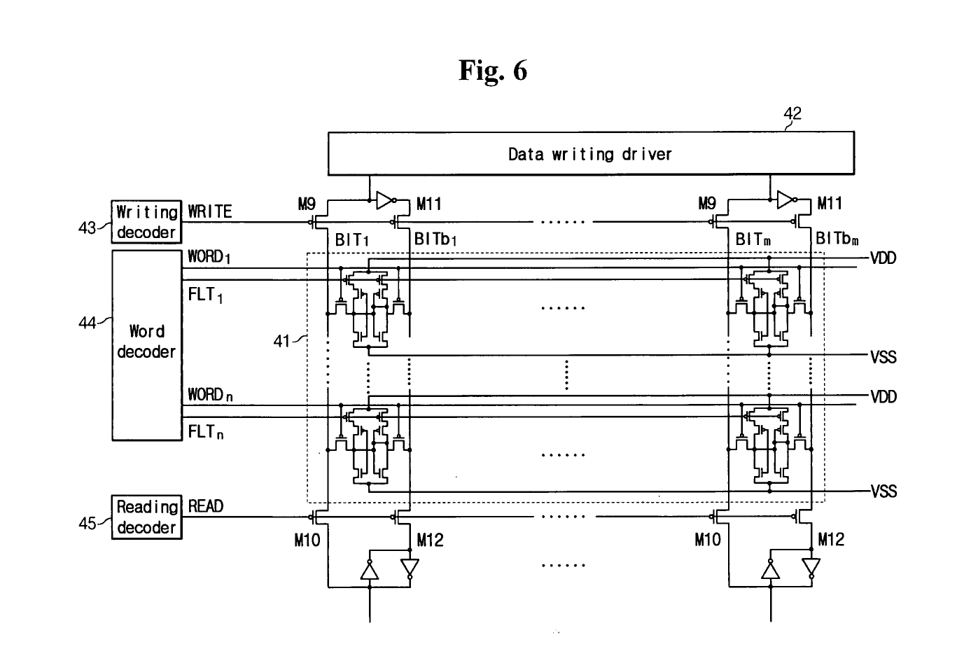

Referring to FIGS. 5 and 6, a flat panel display using an SRAM cell according to an exemplary embodiment of the present invention will be described.

The flat panel display of FIG. 5 has an SoP (system on panel) pattern in which a peripheral circuit is formed on a display panel 1. Such SoP type flat panel display is disclosed in PCT Publication No. WO 01/29814, for example.

As shown in FIG. 5, the display panel 1 of the flat panel display includes a display region 10, a data driver 20, a scan driver 30, a frame memory 40, a memory controller 50, and a timing controller 60. The display panel 1 includes an insulation substrate, a semiconductor layer, and electrodes formed on the insulation substrate.

A plurality of data lines arranged in the column direction and a plurality of scan lines arranged in the row direction are formed on the display region 10, and pixels are formed on the pixel regions defined by two adjacent data lines and two adjacent scan lines. In this instance, each pixel is selected in response to a selecting signal applied from the scan line. Data signals from the data line, for displaying an image, are applied to the pixel to thereby display gray scales.

The data driver 20 applies data signals to the data lines in response to a control signal provided from the timing controller 60, and the scan driver 30 sequentially applies a selecting signal to the scan lines in response to the control signal provided from the timing controller 60. Since the data driver 20 of the SoP type display panel 1 receives digital signals from the frame memory 40, the data driver 20 includes a D/A (digital-to-analog) converter for converting digital signals into analog signals.

The frame memory 40 temporarily stores external input video signals of a single frame by control of the memory controller 50, and outputs digital signals which correspond to the data signals to the data driver 20 row by row.

Referring to FIG. 6, the frame memory 40 will be described in detail.

The frame memory 40 includes an SRAM cell unit 41, a data writing driver 42, a writing decoder 43, a word decoder 44, and a reading decoder 45.

In the SRAM cell unit 41, n word lines WORD1 to WORDn and n floating lines FLT1 to FLTn arranged in the row direction, and m bit lines BIT1 to BITm and m inverse bit lines BITb1 to BITbm arranged in the column direction, are formed. The SRAM cell shown in FIG. 3 is formed at the region defined by two adjacent word lines, a bit line, and an inverse bit line, and (nxm) SRAM cells are formed in a matrix format in the SRAM cell unit 41. Also, when the SRAM cells are formed on the display panel 1, the transistors M1 to M8 forming the SRAM cell can be formed by a TFT (thin film transistor) having the semiconductor layer on the insulation substrate as a channel region and electrodes on the insulation substrate as a drain, a source, and a gate.

In general, the number of SRAM cells formed in the column direction, that is, the number n of word lines, corresponds to the number of scan lines on the display region 10. Further, the SRAM cells of a row within the SRAM cell unit 41 store digital signals which correspond to the data signals applied to pixels of a row within the display region 10. The number of SRAM cells formed in the row direction, that is, the number m of the bit lines, is determined by the number of data line of the display region 10 and the bits of the D/A converter of the data driver 40.

The inverse bit lines BITb1 to BITbm are connected to the bit lines BIT1 to BITm through the inverters, and the bit lines BIT1 to BITm and the inverse bit lines BITb1 to BITbm are connected to the data writing driver 42 through the writing transistors M9 and M11, respectively. Also, output ends of the bit lines BIT1 to BITm and the inverse bit lines BITb1 to BITbm are connected to the reading transistors M10 and M12, and the inverse bit lines BITb1 to BITbm are connected to the bit lines BIT1 to BITm through latches. The word lines WORD1 to WORDn are connected to the gates of the transistors M5′ and M6′ of the SRAM cell of each row, and the floating lines FLT1 to FLTn are connected to the gates of the transistors M7 and M8 of the SRAM cell of each row. In this instance, the transistors M9 to M12 can be formed by TFTs on the insulation substrate.

The data writing driver 42 applies digital signals of a single row to the bit lines BIT1 to BITm. The writing decoder 43 transmits a writing signal to the gates of the writing transistors M9 and M11 when applying the digital signals to the SRAM cell unit 41, and the reading decoder 45 transmits a reading signal to the gates of the reading transistors M10 and M12 when outputting digital signals from the SRAM cell unit 41. The word decoder 44 applies a selecting signal to the word lines WORD1 to WORDn to select SRAM cells on which the digital signals provided from the bit lines BIT may be written, and applies a floating signal to the floating lines FLT1 to FLTn of the SRAM cells on which the digital signals are written to thereby turn off the transistors M7 and M8.

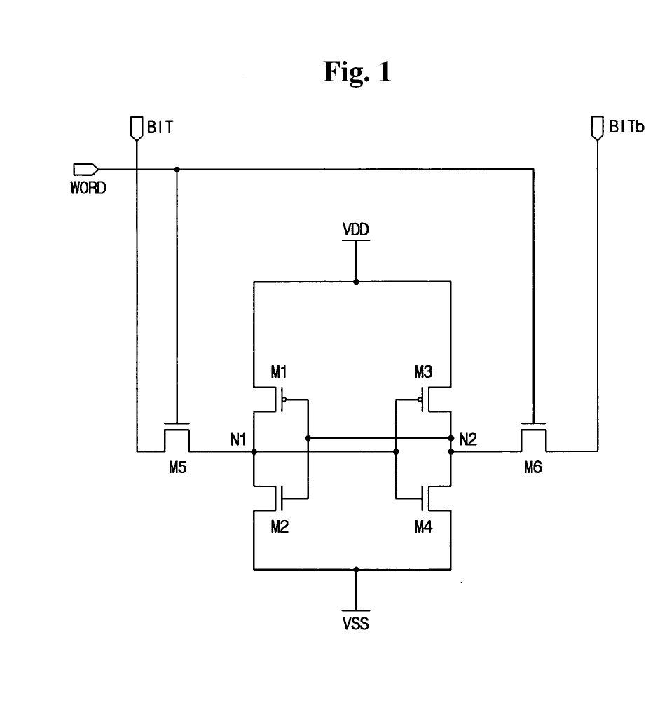

A polycrystalline silicon is generally used for the semiconductor layer of the transistor when the SRAM cell is formed on the insulation substrate of the display panel 1, and deviations of threshold voltages are great in the case of the polycrystalline silicon based TFTs. When the threshold voltage is increased, an On current of the transistor is decreased, and hence, writing data to the SRAM cell of FIG. 1 sometimes fails. When the power supply voltage VDD and the inverter are disconnected when writing data, the data can easily be written to the SRAM cell even though the On current of the transistor is reduced.

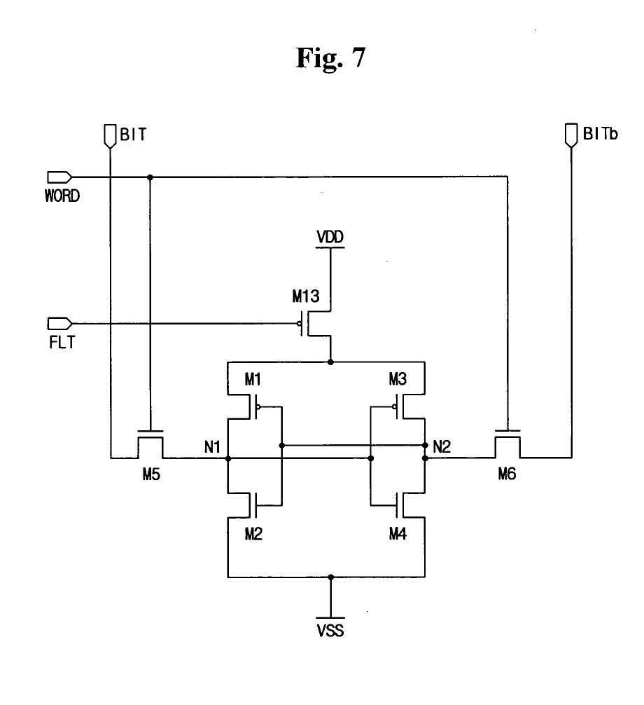

In the above-described exemplary embodiment of the present invention, the transistors M7 and M8 are used between the ends of the two inverters and the power supply voltage VDD as shown in FIG. 2. In other embodiments, a single transistor may be used instead. By way of example, as shown in FIG. 7, the sources of the transistors M1 and M3 are connected, and a transistor M13 can be connected between the sources and the power supply voltage VDD.

According to the present invention, since the inverter of the SRAM cell is decoupled from the power when data is applied, the data is easily written to the SRAM cell without collision of data, and the data is easily written to the SRAM cell when the deviation of the threshold voltage is great.

While this invention has been described in connection with certain exemplary embodiments, it is to be understood that the invention is not limited to the disclosed embodiments, but, on the contrary, is intended to cover various modifications included within the spirit and scope of the appended claims, and equivalents thereof.

1. A semiconductor memory device comprising:
a first inverter having an output end coupled to a first node;
a second inverter having an output end coupled to a second node;
a first switch coupled between a bit line for transmitting first data and the first node;
a second switch coupled between an inverse bit line for transmitting second data having a level opposite the level of the first data and the second node; and
at least one third switch coupled between the first inverter and a first power for supplying a first level voltage and between the second inverter and the first power, wherein
an input end of the first inverter is coupled to the second node, and an input end of the second inverter is coupled to the first node.

2. The semiconductor memory device of claim 1, wherein a period for turning on the first and second switches at least partially overlaps with a period for turning off said at least one third switch.

3. The semiconductor memory device of claim 2, wherein the period for turning on the first and second switches includes the period for turning off said at least one third switch.

4. The semiconductor memory device of claim 1, wherein the first inverter includes a first transistor having a first type coupled between said at least one third switch and the first node, and a second transistor having a second type coupled between the first node and a second power for supplying a second level voltage,
the second inverter includes a third transistor having the first type coupled between said at least one third switch and the second node, and a fourth transistor having the second type coupled between the second node and the second power, and
the first node is coupled to gates of the third and fourth transistors, and the second node is coupled to gates of the first and second transistors.

5. The semiconductor memory device of claim 4, wherein the first level voltage is a high level voltage, and the second level voltage is a low level voltage,
the transistors having the first type are p-channel transistors, and
the transistors having the second type are n-channel transistors.

6. The semiconductor memory device of claim 4, wherein the first, second, third and fourth transistors are thin film transistors formed on a substrate.

7. The semiconductor memory device of claim 1, wherein the first, second and third switches are thin film transistors formed on a substrate.

8. A semiconductor memory device comprising:
a first inverter having an output end coupled to a first node and an input node coupled to a second node;
a second inverter having an output end coupled to the second node and an input node coupled to the first node;
a first power supply line for supplying a first voltage to the first and second inverters; and
a second power supply line for supplying a second voltage to the first and second inverters,
wherein the first power supply line is decoupled from the first and second inverters when data are applied to the first and second nodes.

9. The semiconductor memory device of claim 8, further comprising:
a first switch coupled between the first power supply line and the first inverter; and
a second switch coupled between the first power supply line and the second inverter,
wherein the first and second switches are turned off when the data are applied to the first and second nodes.

10. The semiconductor memory device of claim 8, further comprising a first switch coupled between the first power supply line and the first inverter and between the first power supply line and the second inverter,
wherein the first switch is turned off when the data are applied to the first and second nodes.

11. The semiconductor memory device of claim 8, wherein the first inverter includes a first transistor having a first type coupled between the first power supply line and the first node, and a second transistor having a second type coupled between the first node and a second power supply line,
the second inverter includes a third transistor having the first type coupled between the first power supply line and the second node, and a fourth transistor having the second type coupled between the second node and the second power supply line, and
the first node is coupled to gates of the third and fourth transistors, and the second node is coupled to gates of the first and second transistors.

12. The semiconductor memory device of claim 11, wherein the first, second, third and fourth transistors are thin film transistors.

13. A flat panel display comprising:
a display region for displaying video, the display region including a plurality of data lines arranged in a column direction on an insulation substrate and a plurality of scan lines arranged in a row direction;
a data driver, formed on the insulation substrate, for transmitting data signals for displaying the video to the data lines; and
a frame memory, formed on the insulation substrate, for temporarily storing digital signals which correspond to the data signals, and outputting the digital signals to the data driver,
wherein the frame memory comprises:
a plurality of first signal lines, arranged in the column direction, for transmitting the digital signals;
a plurality of second signal lines, arranged in the column direction, for transmitting inverse signals of the digital signals applied to the first signal lines;
a plurality of third signal lines, arranged in the row direction, for transmitting select signals; and
a plurality of SRAM cells coupled to the first, second and third signal lines, and arranged in a matrix format, and
wherein one said SRAM cell is selected by a corresponding said selecting signal applied to a corresponding said third signal line, and is decoupled from a first power for supplying a first voltage when receiving a corresponding said digital signal from a corresponding said first signal line.

14. The flat panel display of claim 13, wherein each said SRAM cell comprises:
a first inverter having an output end coupled to a corresponding said first signal line through a first transistor, and an input end coupled to a corresponding said second signal line through a second transistor;
a second inverter having an output end coupled to the input end of the first inverter, and an input end coupled to the output end of the first inverter; and
at least one third transistor coupled between a first end of the first inverter and the first power and between a first end of the second inverter and the first power,
wherein gates of the first and second transistors are coupled to a corresponding said third signal line,
a second end of the first inverter and a second end of the second inverter are coupled to a second power for supplying a second voltage, and
said at least one third transistor is turned off when the first and second transistors are turned on and the digital signals and the inverse digital signals are applied through the first and second signal lines.

15. The flat panel display of claim 14, wherein the first, second and said at least one third transistors are thin film transistors formed on the insulation substrate.

16. The flat panel display of claim 14, wherein the first inverter includes a fourth transistor having a first type coupled between the first end and the output end of the first inverter and a fifth transistor having a second type coupled between the output end and the second end of the first inverter,
the second inverter includes a sixth transistor having the first type coupled between the first end and the output end of the second inverter and a seventh transistor having the second type coupled between the output end and the second end of the second inverter, and
gates of the fourth and fifth transistors are coupled to the input end of the first inverter, and gates of the sixth and seventh transistors are coupled to the input end of the second inverter.

17. The flat panel display of claim 16, wherein the fourth, fifth, sixth and seventh transistors are thin film transistors formed on the insulation substrate.

18. The flat panel display of claim 15, wherein the thin film transistors have a semiconductor layer of polycrystalline silicon as a channel region.

19. The flat panel display of claim 14, wherein the frame memory includes a plurality of fourth signal lines arranged in the row direction, and a corresponding said fourth signal line is coupled to a gate of said at least one third transistor of each said SRAM cell.

20. The flat panel display of claim 14, wherein said at least one third transistor includes a fourth transistor coupled between the first end of the first inverter and the first power and a fifth transistor coupled between the first end of the second inverter and the first power.

21. A flat panel display having a semiconductor memory device of any of claims 1-12.
